(19) United States
(12) Patent Application Publication
(10) Pub. No.: US 2026/0237683 A1
(43) Pub. Date: Aug. 13, 2026

(54) ELECTRODE PLATE, BATTERY CELL, AND ELECTRIC DEVICE

(71) Applicant: Ningde Amperex Technology Limited, Ningde (CN)

(72) Inventors: Jiaxiao YAN, Ningde (CN); Fang LV, Ningde (CN); Zhaozhao LIU, Ningde (CN); Changming QU, Ningde (CN)

(73) Assignee: Ningde Amperex Technology Limited, Ningde (CN)

(21) Appl. No.: 19/634,333

(22) Filed: Mar. 31, 2026

Related U.S. Application Data
(63) Continuation of application No. PCT/CN2024/124947, filed on Oct. 15, 2024.

(30) Foreign Application Priority Data
Oct. 23, 2023 (CN) 202311377436.8

(51) Int. Cl. H01M 4/66; H01M 4/70; H01M 50/474; H01M 50/536; H01M 50/54

(52) U.S. Cl. CPC H01M 4/667; H01M 4/668; H01M 4/70; H01M 50/474; H01M 50/536; H01M 50/54

(57) ABSTRACT

A current collector includes a support layer, and a first conductive layer and a second conductive layer disposed on two sides of the support layer in a first direction. The first transition layer is disposed on a surface of the first conductive layer facing away from the support layer. The second transition layer is disposed on a surface of the second conductive layer facing away from the support layer. The first conductive member is disposed on the first conductive layer. The second conductive member is disposed on the second conductive layer. The first conductive member and the second conductive member are welded to form a plurality of weld marks arranged along a second direction, where at least one weld mark is further connected to the current collector. The two protective members are respectively located on two sides of the current collector in the first direction.

### CROSS-REFERENCE TO THE RELATED APPLICATION

This application is a continuation application of International Application No. PCT/CN2024/124947, filed on Oct. 15, 2024, which claims the benefit of priority of Chinese patent application 202311377436.8, filed on Oct. 23, 2023, the contents of which are incorporated herein by reference in its entirety.

### TECHNICAL FIELD

The present application relates to the field of energy storage technologies, and particularly to an electrode plate, a battery cell, and an electric device.

### BACKGROUND

Existing composite current collectors have a three-layer sandwich structure, with a polymer support layer as the central layer and metal layers as the outer layers. An electrode plate made from such a composite current collector can improve safety performance against impacts. When the electrode plate is connected to an electrode terminal (for example, a tab), the composite current collector, due to an intermediate polymer layer incorporated therein, cannot be directly welded to the electrode terminal. An electrical connection member needs to be added between the metal layer and the electrode terminal to achieve electrical connection. When the electrode terminal is bent, the connection between the electrical connection member and the electrode plate is prone to stress-induced cracking and damage, compromising the reliability of the electrode plate.

### SUMMARY

In view of the above situation, it is necessary to provide an electrode plate capable of improving reliability.

An embodiment of the present application provides an electrode plate, the electrode plate including a current collector, a first transition layer, a second transition layer, two active substance layers, a first conductive member, a second conductive member, and two protective members. The current collector includes a support layer, and a first conductive layer and a second conductive layer disposed on both sides of the support layer in a first direction, where the first direction is the thickness direction of the current collector. The current collector includes a first segment and a second segment sequentially disposed along a second direction, where the first direction is perpendicular to the second direction. The first transition layer is located in the first segment and disposed on a surface of the first conductive layer facing away from the support layer. The second transition layer is located in the first segment and disposed on a surface of the second conductive layer facing away from the support layer. One of the two active substance layers is disposed on a surface of the first transition layer facing away from the current collector, and the other active substance layer is disposed on a surface of the second transition layer facing away from the current collector. The first conductive member is disposed on the surface of the first conductive layer facing away from the support layer, where one end of the first conductive member is located in the second segment, and viewed along the first direction, the first conductive member is spaced apart from the first transition layer, and the other end of the first conductive member protrudes beyond the current collector in the second direction. The second conductive member is disposed on the surface of the second conductive layer facing away from the support layer, where one end of the second conductive member is located in the second segment, viewed along the first direction, the second conductive member is spaced apart from the second transition layer, and the other end of the second conductive member protrudes beyond the current collector in the second direction. The first conductive member and the second conductive member are welded to form a plurality of weld marks arranged along the second direction, where at least one weld mark is further connected to the current collector. The two protective members are respectively located on both sides of the current collector in the first direction. One of the protective members has its two ends respectively bonded to a surface of the first conductive member facing away from the current collector and a surface of the corresponding active substance layer facing away from the first transition layer. The other protective member has its two ends respectively bonded to a surface of the second conductive member facing away from the current collector and a surface of the corresponding active substance layer facing away from the second transition layer. Viewed along the second direction, the weld mark connected to the current collector is located between the two protective members.

In the above electrode plate, one of the protective members has its two ends respectively bonded to a surface of the first conductive member facing away from the current collector and a surface of the corresponding active substance layer facing away from the first transition layer, to enhance the stability of the connection between the first conductive member and the current collector. The other protective member has its two ends respectively bonded to a surface of the second conductive member facing away from the current collector and a surface of the corresponding active substance layer facing away from the second transition layer, to enhance the stability of the connection between the second conductive member and the current collector. Viewed along the second direction, the weld mark connected to the current collector is located between the two protective members. The two protective members are configured to protect both sides of the corresponding weld mark, and under the support of the protective members, the stiffness of the first conductive member and the second conductive member located between the two protective members is enhanced. This helps improve the structural strength of the corresponding weld mark, reduces the risk of damage to the weld mark connected to the current collector, and prevents burrs generated by the weld mark from damaging other components, thereby improving the reliability of the electrode plate.

In some embodiments of the present application, along the second direction, a spacing L1 between the first conductive member and the first transition layer satisfies: 0.05 mm≤L1≤0.5 mm, to reduce the risk of a short circuit between the first conductive member and other structural components in the first direction caused by the superposition of the first conductive member and the first transition layer during processing, and decrease the space occupied by the first conductive member in the second direction, thereby contributing to an increase in the energy density of the electrode plate. A spacing L2 between the second conductive member and the second transition layer satisfies: 0.05 mm≤L2≤0.5 mm, to reduce the risk of a short circuit between the second conductive member and other structural components in the first direction caused by the superposition of the second conductive member and the second transition layer during processing, and decrease the space occupied by the second conductive member in the second direction, thereby contributing to an increase in the energy density of the electrode plate.

In some embodiments of the present application, 0.2 mm≤L1≤0.3 mm, to further reduce the risk of a short circuit between the first conductive member and the first transition layer in the first direction caused by the superposition of the first conductive member and other structural components during processing, and decrease the space occupied by the first conductive member in the second direction, thereby contributing to an increase in the energy density of the electrode plate. 0.2 mm≤L2≤0.3 mm, to further reduce the risk of a short circuit between the second conductive member and other structural components in the first direction caused by the superposition of the second conductive member and the second transition layer during processing, and decrease the space occupied by the second conductive member in the second direction, thereby contributing to an increase in the energy density of the electrode plate.

In some embodiments of the present application, along the second direction, a spacing L3 between the first transition layer and an adjacent weld mark satisfies 0.05 mm≤L3≤1 mm; and a spacing L4 between the second transition layer and an adjacent weld mark satisfies 0.05 mm≤L4≤1 mm, to reduce the risk of false welding caused by the connection of the weld mark with the first transition layer and the second transition layer, and decrease the space occupied by the weld mark in the second direction, thereby contributing to an increase in the energy density of the electrode plate.

In some embodiments of the present application, 0.1 mm≤L3≤0.2 mm; 0.1 mm≤L4≤0.2 mm, to further reduce the risk of false welding caused by the connection of the weld mark with the first transition layer and the second transition layer, and decrease the space occupied by the weld mark in the second direction, thereby contributing to an increase in the energy density of the electrode plate.

In some embodiments of the present application, along the second direction, the width W1 of each weld mark satisfies: 1.5 mm≤W1≤4 mm, to enhance connection strength and decrease the space occupied by the weld mark, thereby reducing the risk of interference with subsequent processes. Along the first direction, the height H1 of each weld mark satisfies: 20 μm≤H1≤50 μm, to enhance the connection strength of the weld mark and reduce the risk of over-welding or false welding.

In some embodiments of the present application, 1.6 mm≤W1≤2.2 mm, to further enhance connection strength and decrease the space occupied by the weld mark, thereby reducing the risk of interference with subsequent processes. 30 μm≤H1≤35 μm, to further enhance the connection strength of the weld mark and reduce the risk of over-welding or false welding.

In some embodiments of the present application, along the second direction, the width W2 of each protective member satisfies 1.2 mm≤W2≤5 mm, to enhance the stability of insulating and isolating the weld mark from other structural components and decrease the space occupied by the protective member, thereby reducing the risk of interference with subsequent processes. The width W3 of the bonding region between each protective member and the corresponding active substance layer satisfies 0<W3≤1 mm, to reduce the impact of the bonding region on the capacity performance of the active substance layer, thereby contributing to an increase in the energy density of the electrode plate.

In some embodiments of the present application, 2 mm≤W2≤2.4 mm, to further enhance the stability of insulating and isolating the weld mark from other structural components and decrease the space occupied by the protective member, thereby reducing the risk of interference with subsequent processes. 0.2 mm≤W3≤0.4 mm, to further reduce the impact of the bonding region on the capacity performance of the active substance layer, thereby contributing to an increase in the energy density of the electrode plate.

In some embodiments of the present application, along the first direction, the thickness H2 of each protective member satisfies: 5 μm≤H2≤40 μm, to enhance the stiffness of the corresponding first conductive member or second conductive member and reduce space waste caused by the protective member, thereby contributing to an increase in the energy density of the electrode plate.

In some embodiments of the present application, 15 μm≤H2≤20 μm, to further enhance the stiffness of the corresponding first conductive member or second conductive member and reduce space waste caused by the protective member, thereby contributing to an increase in the energy density of the electrode plate.

In some embodiments of the present application, along the first direction, the thickness H3 of the first conductive member satisfies 8 μm≤H3≤20 μm; and the thickness H4 of the second conductive member satisfies 8 μm≤H4≤20 μm, to enhance the structural strength of the first conductive member and the second conductive member and reduce space waste caused by the first conductive member and the second conductive member, thereby contributing to an increase in the energy density of the electrode plate.

In some embodiments of the present application, 8 μm≤H3≤10 μm; and 8 μm≤H4≤10 μm, to further enhance the structural strength of the first conductive member and the second conductive member and reduce space waste caused by the first conductive member and the second conductive member, thereby contributing to an increase in the energy density of the electrode plate.

In some embodiments of the present application, along the first direction, the thickness H5 of the current collector satisfies: 4 μm≤H5≤20 μm, to meet the structural strength requirements of the current collector and reduce space waste caused by the current collector occupying excessive space, thereby contributing to an increase in the energy density of the electrode plate. The thickness H6 of the first transition layer satisfies: 0.5 μm≤H6≤4 μm; and the thickness H7 of the second transition layer satisfies: 0.5 μm≤H7≤4 μm, to enhance the connection strength of the first transition layer and the second transition layer and reduce space waste caused by the first transition layer and the second transition layer, thereby contributing to an increase in the energy density of the electrode plate.

In some embodiments of the present application, 6 μm≤H5≤10 μm, to further meet the structural strength requirements of the current collector and reduce space waste caused by the current collector occupying excessive space, thereby contributing to an increase in the energy density of the electrode plate. 1.5 μm≤H6≤2.5 μm; and 1.5 μm≤H7≤2.5 μm, to further enhance the connection strength of the first transition layer and the second transition layer and reduce space waste caused by the first transition layer and the second transition layer, thereby contributing to an increase in the energy density of the electrode plate.

In some embodiments of the present application, along the second direction, the width W4 of the second segment satisfies 1 mm≤W4≤5 mm, to enhance the connection strength between the second segment and the first conductive member and the second conductive member and reduce space waste caused by the second segment, thereby contributing to an increase in the energy density of the electrode plate.

In some embodiments of the present application, 1.5 mm≤W4≤2.2 mm, to further enhance the connection strength between the second segment and the first conductive member and the second conductive member and reduce space waste caused by the second segment, thereby contributing to an increase in the energy density of the electrode plate.

In some embodiments of the present application, the current collector further includes a third segment. Along the second direction, the third segment is located at an end of the first segment away from the second segment, and the third segment is configured to connect to an electrode terminal. The width W5 of the third segment satisfies 1 mm≤W5≤5 mm, to enhance the connection strength between the third segment and the electrode terminal and reduce space waste caused by the third segment, thereby contributing to an increase in the energy density of the electrode plate.

In some embodiments of the present application, the first transition layer and the second transition layer each include an inorganic material, a polymer material, and conductive particles. The inorganic material includes one or more of alumina, boehmite, silica, water-insoluble carbonates, and water-insoluble sulfates. The polymer material includes one or more of polyolefins, polyesters, and rubbers.

An embodiment of the present application further provides a battery cell, where the battery cell includes an electrode assembly, and the electrode assembly includes any one of the electrode plates described in the above embodiments.

An embodiment of the present application further provides an electric device, including any one of the electrode plates described in the above embodiments or any one of the battery cells described in the above embodiments.

In the above electrode plate, battery cell, and electric device, one of the protective members has its two ends respectively bonded to a surface of the first conductive member facing away from the current collector and a surface of the corresponding active substance layer facing away from the first transition layer, to enhance the stability of the connection between the first conductive member and the current collector. The other protective member has its two ends respectively bonded to a surface of the second conductive member facing away from the current collector and a surface of the corresponding active substance layer facing away from the second transition layer, to enhance the stability of the connection between the second conductive member and the current collector. Viewed along the second direction, the weld mark connected to the current collector is located between the two protective members. The two protective members are configured to protect both sides of the corresponding weld mark, and under the support of the protective members, the stiffness of the first conductive member and the second conductive member located between the two protective members is enhanced. This helps improve the structural strength of the corresponding weld mark, reduces the risk of damage to the weld mark connected to the current collector, and prevents burrs generated by the weld mark from damaging other components, thereby improving the reliability of the electrode plate.

### BRIEF DESCRIPTION OF DRAWINGS

FIG. 1 is a schematic plan view of an electrode plate according to an embodiment of the present application.

FIG. 2 is a cross-sectional view along line A-A of FIG. 1.

FIG. 3 is a schematic structural diagram of a battery cell according to an embodiment of the present application.

FIG. 4 is a schematic structural diagram of an electric device according to an embodiment of the present application.

### DESCRIPTION OF REFERENCE SIGNS

Electrode plate 100
Battery cell 200
Electric device 300
Current collector 10
Support layer 11
First conductive layer 12
Second conductive layer 13
First transition layer 20
First outer edge portion 21
Second transition layer 30
Second outer edge portion 31
Active substance layer 40
First conductive member 50
First gap 51
Second conductive member 60
Second gap 61
Protective member 70
Electrode assembly 201
First electrode plate 100a
Second electrode plate 100b
Separator 80
Tab 202
Tab lead 203
First direction Z
Second direction X

The following detailed description will further explain the present application in conjunction with the above drawings.

### DESCRIPTION OF EMBODIMENTS

The technical solutions in some embodiments of the present application will be described below with reference to the drawings in these embodiments of the present application. Apparently, the described embodiments are only some rather than all embodiments of the present application.

It should be noted that when an element is referred to as being “connected” to another element, it may be directly connected to the other element, or there may be an intervening element. When an element is referred to as being “disposed” on another element, it may be directly disposed on the other element, or there may be an intervening element. When a value is considered “equal” to another value, it means that the two are equal within a set tolerance, with the tolerance range being within 5%. That is, when at least one of the two values fluctuates within the set tolerance range, even if their values are not equal, they are still deemed substantially equal. When a ratio between two values is considered “1:1,” it means that the two are equal within a set tolerance, with the tolerance range being within 5%. That is, when at least one of the two values fluctuates within the set tolerance range, even if their values are not equal, their ratio is still deemed equal.

Unless otherwise defined, all technical and scientific terms used herein have the same meaning as commonly understood by those skilled in the technical field of the present application. The terms used in the specification of the present application are for the purpose of describing specific embodiments only and are not intended to limit the present application. The term “and/or” as used herein includes any and all combinations of one or more related listed items.

It should be understood that, considering actual processing tolerances, the term “perpendicular” in the technical solutions of the present application is used to describe an ideal state between two components. In actual production or use, an approximately perpendicular state may exist between the two components. For example, in terms of numerical description, perpendicular may refer to an angle between two lines ranging from 90°±10°, an angle between two planes ranging from 90°±10°, or an angle between a line and a plane ranging from 90°±10°. The two components described as “perpendicular” may not be absolutely straight lines or planes; they may be roughly straight or planar, and as long as their overall extension direction appears straight or planar from a macroscopic perspective, they can be considered as a “straight line” or “plane.”

An embodiment of the present application provides an electrode plate, the electrode plate including a current collector, a first transition layer, a second transition layer, two active substance layers, a first conductive member, a second conductive member, and two protective members. The current collector includes a support layer, and a first conductive layer and a second conductive layer disposed on both sides of the support layer in a first direction, where the first direction is the thickness direction of the current collector. The current collector includes a first segment and a second segment sequentially disposed along a second direction, where the first direction is perpendicular to the second direction. The first transition layer is located in the first segment and disposed on a surface of the first conductive layer facing away from the support layer. The second transition layer is located in the first segment and disposed on a surface of the second conductive layer facing away from the support layer. One of the two active substance layers is disposed on a surface of the first transition layer facing away from the current collector, and the other active substance layer is disposed on a surface of the second transition layer facing away from the current collector. The first conductive member is disposed on the surface of the first conductive layer facing away from the support layer, where one end of the first conductive member is located in the second segment, viewed along the first direction, the first conductive member is spaced apart from the first transition layer, and the other end of the first conductive member protrudes beyond the current collector in the second direction. The second conductive member is disposed on the surface of the second conductive layer facing away from the support layer, where one end of the second conductive member is located in the second segment, viewed along the first direction, the second conductive member is spaced apart from the second transition layer, and the other end of the second conductive member protrudes beyond the current collector in the second direction. The first conductive member and the second conductive member are welded to form a plurality of weld marks arranged along the second direction, where at least one weld mark is further connected to the current collector. The two protective members are respectively located on both sides of the current collector in the first direction. One of the protective members has its two ends respectively bonded to a surface of the first conductive member facing away from the current collector and a surface of the corresponding active substance layer facing away from the first transition layer. The other protective member has its two ends respectively bonded to a surface of the second conductive member facing away from the current collector and a surface of the corresponding active substance layer facing away from the second transition layer. Viewed along the second direction, the weld mark connected to the current collector is located between the two protective members.

In the above electrode plate, one of the protective members has its two ends respectively bonded to a surface of the first conductive member facing away from the current collector and a surface of the corresponding active substance layer facing away from the first transition layer, to enhance the stability of the connection between the first conductive member and the current collector. The other protective member has its two ends respectively bonded to a surface of the second conductive member facing away from the current collector and a surface of the corresponding active substance layer facing away from the second transition layer, to enhance the stability of the connection between the second conductive member and the current collector. Viewed along the second direction, the weld mark connected to the current collector is located between the two protective members. The two protective members are configured to protect both sides of the corresponding weld mark, and under the support of the protective members, the stiffness of the first conductive member and the second conductive member located between the two protective members is enhanced. This helps improve the structural strength of the corresponding weld mark, reduces the risk of damage to the weld mark connected to the current collector, and prevents burrs generated by the weld mark from damaging other components, thereby improving the reliability of the electrode plate.

The embodiments of the present application will be further described below with reference to the accompanying drawings.

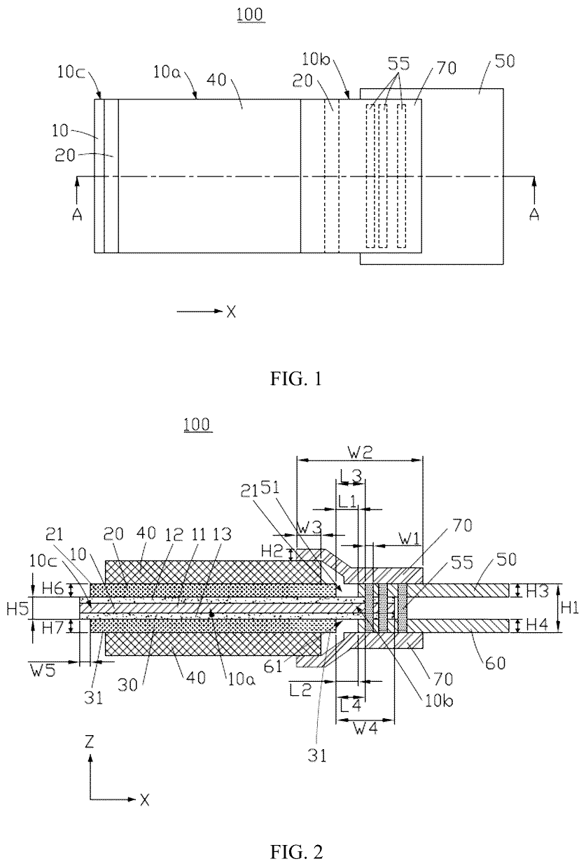

Referring to FIG. 1 and FIG. 2 together, an embodiment of the present application provides an electrode plate 100, where the electrode plate 100 is used to form a battery cell for application in a secondary battery. A secondary battery refers to a battery that can be recharged to reactivate the active material for continued use after discharge. Optionally, the electrode plate 100 may be a positive electrode plate or a negative electrode plate.

The electrode plate 100 includes a current collector 10, a first transition layer 20, a second transition layer 30, two active substance layers 40, a first conductive member 50, a second conductive member 60, and two protective members 70.

The current collector 10 is a composite current collector configured to collect current. Specifically, the current collector 10 includes a support layer 11, and a first conductive layer 12 and a second conductive layer 13 disposed on both sides of the support layer 11 in a first direction Z. The first direction Z is the thickness direction of the current collector 10.

The support layer 11 is made of a polymer insulating material and has high structural strength and low density and weight, enabling a reduction in the thickness and weight of the current collector 10. Optionally, the polymer insulating material includes one or more of polyethylene terephthalate (Polyethylene terephthalate, PET), polypropylene (PP), polyethylene (Polyethylene, PE), polyimide (Polyimide, PI), polyetherketone (Polyetherketone, PEK), and polyphenylene sulfide (Polyphenylene sulfide, PPS).

The first conductive layer 12 and the second conductive layer 13 are made of a metallic material. Compared to conventional current collectors made entirely of metal, the first conductive layer 12 and the second conductive layer 13 disposed on both sides of the support layer 11 are thinner. When the current collector 10 is subjected to mechanical damage from external impact, this configuration helps reduce the generation of metal burrs, thereby lowering the risk of short circuits. Optionally, the metallic material includes one or more of aluminum, copper, nickel, silver, gold, and iron.

The current collector 10 includes a first segment 10a and a second segment 10b sequentially disposed along a second direction X, where the first direction Z is perpendicular to the second direction X. Optionally, the second direction X is the width direction of the current collector 10. The first segment 10a is configured to connect to the first transition layer 20 and the second transition layer 30, and the second segment 10b is configured to connect to the first conductive member 50 and the second conductive member 60.

The first transition layer 20 is located in the first segment 10a and disposed on a surface of the first conductive layer 12 facing away from the support layer 11. The second transition layer 30 is located in the first segment 10a and disposed on a surface of the second conductive layer 13 facing away from the support layer 11. The first transition layer 20 and the second transition layer 30 are respectively configured to connect to the corresponding active substance layers 40 to enhance the connection strength between the active substance layers 40 and the current collector 10.

The first transition layer 20 includes an inorganic material, a polymer material, and conductive particles. The inorganic material includes one or more of alumina, boehmite, silica, water-insoluble carbonates, and water-insoluble sulfates. The polymer material includes one or more of polyolefins, polyesters, and rubbers. The second transition layer 30 includes an inorganic material, a polymer material, and conductive particles. The inorganic material includes one or more of alumina, boehmite, silica, water-insoluble carbonates, and water-insoluble sulfates. The polymer material includes one or more of polyolefins, polyesters, and rubbers.

One of the active substance layers 40 is disposed on a surface of the first transition layer 20 facing away from the current collector 10, and the other active substance layer 40 is disposed on a surface of the second transition layer 30 facing away from the current collector 10. The active substance layers 40 are configured to generate current, and the current generated by the active substance layers 40 is collected to the current collector 10 through the corresponding first transition layer 20 and second transition layer 30.

In some embodiments, the active substance layer 40 exhibits positive polarity, and the active substance layer 40 is applied to the surface of the first transition layer 20 facing away from the current collector 10 or the surface of the second transition layer 30 facing away from the current collector 10 by a process such as extrusion coating, transfer coating, or spray coating. The coating weight of the active substance layer 40 is 100 mg/1540.25 mm² to 400 mg/1540.25 mm². Optionally, the coating weight of the active substance layer 40 may be one of 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, with the corresponding unit being mg/1540.25 mm².

The first conductive member 50 is disposed on the surface of the first conductive layer 12 facing away from the support layer 11, where one end of the first conductive member 50 is located in the second segment 10b, and viewed along the first direction Z, the first conductive member 50 is spaced apart from the first transition layer 20, forming a first gap 51 to reduce the risk of a short circuit between the first conductive member 50 and other structural components in the first direction Z caused by the superposition of the first conductive member 50 and the first transition layer 20. The other structural components may include, but are not limited to, adjacent electrode plates of different polarity. The other end of the first conductive member 50 protrudes beyond the current collector 10 in the second direction X to facilitate connection with an electrode terminal.

The second conductive member 60 is disposed on the surface of the second conductive layer 13 facing away from the support layer 11, where one end of the second conductive member 60 is located in the second segment 10b, and viewed along the first direction Z, the second conductive member 60 is spaced apart from the second transition layer 30, forming a second gap 61 to reduce the risk of a short circuit between the second conductive member 60 and other structural components in the first direction Z caused by the superposition of the second conductive member 60 and the second transition layer 30. The other structural components may include, but are not limited to, adjacent electrode plates of different polarity. The other end of the second conductive member 60 protrudes beyond the current collector 10 in the second direction X to facilitate connection with an electrode terminal.

The first conductive member 50 and the second conductive member 60 are welded to form a plurality of weld marks 55 arranged along the second direction X At least one weld mark 55 is further connected to the current collector 10 to enhance the connection strength between the first conductive member 50 and the second conductive member 60 and the current collector 10. Specifically, the first conductive member 50 and the second conductive member 60 are each an aluminum strip, and the weld mark 55 connected to the current collector 10 is formed by roll welding the first conductive member 50, the second conductive member 60, and the current collector 10 located between the first conductive member 50 and the second conductive member 60. The weld mark 55 extends through the corresponding current collector 10 along the first direction Z to connect the first conductive member 50 and the second conductive member 60. The weld mark 55 not connected to the current collector 10 is formed by roll welding the first conductive member 50 and the second conductive member 60.

In some embodiments, the number of weld marks 55 is three, where two weld marks 55 are further connected to the current collector 10.

Optionally, in other embodiments, the number of weld marks 55 may be 2, 4, 5, 6, or any other natural number greater than 2.

The two protective members 70 are respectively located on both sides of the current collector 10 in the first direction Z. The protective member 70 is made of a polyolefin-based hot-melt adhesive material and provided with adhesiveness and insulation. One of the protective members 70 has its two ends respectively bonded to a surface of the first conductive member 50 facing away from the current collector 10 and a surface of the corresponding active substance layer 40 facing away from the first transition layer 20, to enhance the stability of the connection between the first conductive member 50 and the current collector 10. The other protective member 70 has its two ends respectively bonded to a surface of the second conductive member 60 facing away from the current collector 10 and a surface of the corresponding active substance layer 40 facing away from the second transition layer 30, to enhance the stability of the connection between the second conductive member 60 and the current collector 10.

Viewed along the second direction X, the weld mark 55 connected to the current collector 10 is located between the two protective members 70. The two protective members 70 are configured to protect both sides of the corresponding weld mark 55, and under the support of the protective members 70, the stiffness of the first conductive member 50 and the second conductive member 60 located between the two protective members 70 is enhanced. This helps improve the structural strength of the corresponding weld mark 55, reduces the risk of damage to the weld mark 55 connected to the current collector 10, and improves the reliability of the electrode plate 100. Furthermore, the two protective members 70 are also configured to insulate and isolate the corresponding weld mark 55 from other structural components in the first direction Z, reducing the risk of short circuits and improving the reliability of the electrode plate 100.

In some embodiments, all weld marks 55 are located between the two protective members 70, to further help improve the structural strength of the corresponding weld marks 55, reduce the risk of damage to the weld marks 55 connected to the current collector 10, and improve the reliability of the electrode plate 100.

In the above electrode plate 100, one of the protective members 70 has its two ends respectively bonded to a surface of the first conductive member 50 facing away from the current collector 10 and a surface of the corresponding active substance layer 40 facing away from the first transition layer 20, to enhance the stability of the connection between the first conductive member 50 and the current collector 10. The other protective member 70 has its two ends respectively bonded to a surface of the second conductive member 60 facing away from the current collector 10 and a surface of the corresponding active substance layer 40 facing away from the second transition layer 30, to enhance the stability of the connection between the second conductive member 60 and the current collector 10. Viewed along the second direction X, the weld mark 55 connected to the current collector 10 is located between the two protective members 70. The two protective members 70 are configured to protect both sides of the corresponding weld mark 55, and under the support of the protective members 70, the stiffness of the first conductive member 50 and the second conductive member 60 located between the two protective members 70 is enhanced. This helps improve the structural strength of the corresponding weld mark 55, reduces the risk of damage to the weld mark 55 connected to the current collector 10, and prevents burrs generated by the weld mark 55 from damaging other components, thereby improving the reliability of the electrode plate 100.

Referring to FIG. 1 and FIG. 2 together, in some embodiments, along the second direction X, a spacing L1 between the first conductive member 50 and the first transition layer 20 satisfies: 0.05 mm≤L1≤0.5 mm. When L1 is too small (less than 0.05 mm), it is likely to lead to a short circuit between the first conductive member 50 and other structural components in the first direction Z caused by the superposition of the first conductive member 50 and the first transition layer 20 during processing. When L1 is too large (greater than 0.5 mm), it is likely to cause the first conductive member 50 to occupy excessive space in the second direction X, resulting in space waste. By limiting 0.05 mm≤L1≤0.5 mm, the risk of a short circuit between the first conductive member 50 and other structural components in the first direction Z caused by the superposition of the first conductive member 50 and the first transition layer 20 during processing is reduced, and the space occupied by the first conductive member 50 in the second direction X is decreased, thereby contributing to an increase in the energy density of the electrode plate 100.

Optionally, L1 may be one of 0.05 mm, 0.06 mm, 0.07 mm, 0.08 mm, 0.09 mm, 0.1 mm, 0.2 mm, 0.3 mm, 0.4 mm, 0.5 mm, or any other value within the range of 0.05 mm to 0.5 mm.

Further, 0.2 mm≤L1≤0.3 mm, to further reduce the risk of a short circuit between the first conductive member 50 and other structural components in the first direction Z caused by the superposition of the first conductive member 50 and the first transition layer 20 during processing, and decrease the space occupied by the first conductive member 50 in the second direction X, thereby contributing to an increase in the energy density of the electrode plate 100.

Referring to FIG. 1 and FIG. 2 together, in some embodiments, along the second direction X, a spacing L2 between the second conductive member 60 and the second transition layer 30 satisfies: 0.05 mm≤L2≤0.5 mm. When L2 is too small (less than 0.05 mm), it is likely to lead to a short circuit between second conductive member 60 and other structural components in the first direction Z caused by the superposition of the second conductive member 60 and the second transition layer 30 during processing. When L2 is too large (greater than 0.5 mm), it is likely to cause the second conductive member 60 to occupy excessive space in the second direction X, resulting in space waste. By limiting 0.05 mm≤L2≤0.5 mm, the risk of a short circuit between second conductive member 60 and other structural components in the first direction Z caused by the superposition of the second conductive member 60 and the second transition layer 30 during processing is reduced, and the space occupied by the second conductive member 60 in the second direction X is decreased, thereby contributing to an increase in the energy density of the electrode plate 100.

Optionally, L2 may be one of 0.05 mm, 0.06 mm, 0.07 mm, 0.08 mm, 0.09 mm, 0.1 mm, 0.2 mm, 0.3 mm, 0.4 mm, 0.5 mm, or any other value within the range of 0.05 mm to 0.5 mm.

Further, 0.2 mm≤L2≤0.3 mm, to further reduce the risk of a short circuit between the second conductive member 60 and other structural components in the first direction Z caused by the superposition of the second conductive member 60 and the second transition layer 30 during processing, and decrease the space occupied by the second conductive member 60 in the second direction X, thereby contributing to an increase in the energy density of the electrode plate 100.

In some embodiments, L1=L2, and along the first direction Z, projections of the first gap 51 and the second gap 61 overlap, so that the load-bearing positions between the first transition layer 20 and the first conductive member 50 are approximately aligned with those between the second transition layer 30 and the second conductive member 60. This helps ensure uniform stress distribution on both sides of the current collector 10, thereby improving the structural stability and reliability of the electrode plate 100.

Referring to FIG. 1 and FIG. 2 together, in some embodiments, along the second direction X, a spacing L3 between the first transition layer 20 and an adjacent weld mark 55 satisfies 0.05 mm≤L3≤1 mm; and a spacing L4 between the second transition layer 30 and an adjacent weld mark 55 satisfies 0.05 mm≤L4≤1 mm. When the spacing between the first transition layer 20 and the second transition layer 30 and the corresponding weld mark 55 is too small (less than 0.05 mm), it is likely to cause the weld mark 55 to connect with the first transition layer 20 and the second transition layer 30 during formation, leading to a risk of false welding of the weld mark 55. When the spacing between the first transition layer 20 and the second transition layer 30 and the corresponding weld mark 55 is too large (greater than 1 mm), it is likely to cause the weld mark 55 to occupy excessive space in the second direction X, resulting in space waste. By limiting 0.05 mm≤L3≤1 mm and 0.05 mm≤L4≤1 mm, the risk of false welding caused by the connection of the weld mark 55 with the first transition layer 20 and the second transition layer 30 is reduced, and the space occupied by the weld mark 55 in the second direction X is minimized, thereby contributing to an increase in the energy density of the electrode plate 100.

Optionally, L3 may be one of 0.05 mm, 0.06 mm, 0.07 mm, 0.08 mm, 0.09 mm, 0.1 mm, 0.2 mm, 0.3 mm, 0.4 mm, 0.5 mm, 0.6 mm, 0.7 mm, 0.8 mm, 0.9 mm, 1 mm, or any other value within the range of 0.05 mm to 1 mm; L4 may be one of 0.05 mm, 0.06 mm, 0.07 mm, 0.08 mm, 0.09 mm, 0.1 mm, 0.2 mm, 0.3 mm, 0.4 mm, 0.5 mm, 0.6 mm, 0.7 mm, 0.8 mm, 0.9 mm, 1 mm, or any other value within the range of 0.05 mm to 1 mm.

Further, 0.1 mm≤L3≤0.2 mm; and 0.1 mm≤L4≤0.2 mm, to further reduce the risk of false welding caused by the connection of the weld mark 55 with the first transition layer 20 and the second transition layer 30, and decrease the space occupied by the weld mark 55 in the second direction X, thereby contributing to an increase in the energy density of the electrode plate 100.

In some embodiments, L3=L4, so that the load-bearing positions between the first transition layer 20 and the corresponding weld mark 55 are approximately aligned with those between the second transition layer 30 and the corresponding weld mark 55. This helps ensure uniform stress distribution on both sides of the current collector 10, thereby improving the structural stability and reliability of the electrode plate 100.

Referring to FIG. 1 and FIG. 2 together, in some embodiments, along the second direction X, the length of the active substance layer 40 on the first transition layer 20 is less than the length of the first transition layer 20. Viewed along the first direction Z, the first transition layer 20 includes two first outer edge portions 21 protruding beyond both sides of the corresponding active substance layer 40 in the second direction X. Along the second direction X, the width of the first outer edge portion 21 is 1 mm to 1.8 mm. When the width of the first outer edge portion 21 is too small (less than 1 mm), it is not conducive to meeting processing tolerance requirements; and when the width of the first outer edge portion 21 is too large (greater than 1.8 mm), it is likely to cause the first outer edge portion 21 to occupy excessive space in the second direction X, resulting in space waste. By limiting the width of the first outer edge portion 21 to 1 mm to 1.8 mm, space waste caused by the first outer edge portion 21 in the second direction X can be reduced while meeting processing tolerance requirements.

Optionally, along the second direction X, the widths of the two first outer edge portions 21 are equal.

Optionally, the width of the first outer edge portion 21 may be one of 1 mm, 1.1 mm, 1.2 mm, 1.3 mm, 1.4 mm, 1.5 mm, 1.6 mm, 1.7 mm, 1.8 mm, or any other value within the range of 1 mm to 1.8 mm.

Further, the width of the first outer edge portion 21 is 1.6 mm to 1.8 mm, to further reduce space waste caused by the first outer edge portion 21 in the second direction X while meeting processing tolerance requirements.

Referring to FIG. 1 and FIG. 2 together, in some embodiments, along the second direction X, the length of the active substance layer 40 on the second transition layer 30 is less than the length of the second transition layer 30. Viewed along the first direction Z, the second transition layer 30 includes two second outer edge portions 31 protruding beyond both sides of the corresponding active substance layer 40 in the second direction X. Along the second direction X, the width of the second outer edge portion 31 is 1 mm to 1.8 mm. When the width of the second outer edge portion 31 is too small (less than 1 mm), it is not conducive to meeting processing tolerance requirements; and when the width of the second outer edge portion 31 is too large (greater than 1.8 mm), it is likely to cause the second outer edge portion 31 to occupy excessive space in the second direction X, resulting in space waste. By limiting the width of the second outer edge portion 31 to 1 mm to 1.8 mm, space waste caused by the second outer edge portion 31 in the second direction X can be reduced while meeting processing tolerance requirements.

Optionally, along the second direction X, the widths of the two second outer edge portions 31 are equal.

Optionally, the width of the second outer edge portion 31 may be one of 1 mm, 1.1 mm, 1.2 mm, 1.3 mm, 1.4 mm, 1.5 mm, 1.6 mm, 1.7 mm, 1.8 mm, or any other value within the range of 1 mm to 1.8 mm.

Further, the width of the second outer edge portion 31 is 1.6 mm to 1.8 mm, to further reduce space waste caused by the second outer edge portion 31 in the second direction X while meeting processing tolerance requirements.

Referring to FIG. 1 and FIG. 2 together, in some embodiments, along the second direction X, the width W1 of each weld mark 55 satisfies: 1.5 mm≤W1≤4 mm. When the width W1 of the weld mark 55 is small (less than 1.5 mm), it is likely to result in weak connection strength; when the width W1 of the weld mark 55 is large (greater than 1.8 mm), it is likely to cause the weld mark 55 to occupy excessive space and interfere with subsequent processes for connecting the first conductive member 50 and the second conductive member 60 to the electrode terminal. By limiting 1.5 mm≤W1≤4 mm, the connection strength is enhanced, and the space occupied by the weld mark 55 is reduced, thereby reducing the risk of interference with subsequent processes.

Optionally, W1 may be one of 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, or any other value within the range of 1.5 mm to 4 mm.

Further, 1.6 mm≤W1≤2.2 mm, to further enhance connection strength and reduce the space occupied by the weld mark 55, thereby reducing the risk of interference with subsequent processes.

Referring to FIG. 1 and FIG. 2 together, in some embodiments, along the first direction Z, the height H1 of each weld mark 55 satisfies: 20 μm≤H1≤50 μm. When the height of the weld mark 55 is small (less than 20 μm), it is likely to cause over-welding during the welding process, leading to fracture or detachment at the welding position; and when the height of the weld mark is large (greater than 50 μm), it is likely to cause false welding during the welding process, leading to fracture or detachment at the welding position. By limiting 20 μm≤H1≤50 μm, the connection strength of the weld mark 55 is enhanced, and the risk of over-welding or false welding is reduced.

Optionally, H1 may be one of 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, or any other value within the range of 20 μm to 50 μm.

Further, 30 μm≤H1≤35 μm, to further enhance the connection strength of the weld mark 55 and reduce the risk of over-welding or false welding.

Referring to FIG. 1 and FIG. 2 together, in some embodiments, along the second direction X, the width W2 of each protective member 70 satisfies 1.2 mm≤W2≤5 mm. When the width of the protective member 70 is small (less than 1.2 mm), it reduces the stability of insulating and isolating the weld mark 55 from other structural components, making it easy for the weld mark 55 to contact an adjacent electrode plate of different polarity, causing a short circuit; and when the width of the protective member 70 is large (greater than 5 mm), it is likely to cause the protective member 70 to occupy excessive space, resulting in space waste, and interfere with subsequent processes for connecting the first conductive member 50 and the second conductive member 60 to the electrode terminal. By limiting 1.2 mm≤W2≤5 mm, the stability of insulating and isolating the weld mark 55 from other structural components is enhanced, and the space occupied by the protective member 70 is reduced, thereby reducing the risk of interference with subsequent processes.

Optionally, W2 may be one of 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or any other value within the range of 1.2 mm to 5 mm.

Further, 2 mm≤W2≤2.4 mm, to further enhance the stability of insulating and isolating the weld mark 55 from other structural components and reduce space waste caused by the protective member 70, thereby reducing the risk of interference with subsequent processes.

Referring to FIG. 1 and FIG. 2 together, in some embodiments, the width W3 of the bonding region between each protective member 70 and the corresponding active substance layer 40 satisfies 0<W3≤1 mm, to reduce the impact of the bonding region on the capacity performance of the active substance layer 40, thereby contributing to an increase in the energy density of the electrode plate 100.

Optionally, W3 may be one of 0.1 mm, 0.2 mm, 0.3 mm, 0.4 mm, 0.5 mm, 0.6 mm, 0.7 mm, 0.8 mm, 0.9 mm, 1 mm, or any other value within the range of 0 mm to 1 mm.

Further, 0.2 mm≤W3≤0.4 mm, to further reduce the impact of the bonding region on the capacity performance of the active substance layer 40, thereby contributing to an increase in the energy density of the electrode plate 100.

Referring to FIG. 1 and FIG. 2 together, in some embodiments, along the first direction Z, the thickness H2 of each protective member 70 satisfies: 5 μm≤H2≤40 μm. When the thickness of the protective member 70 is small (less than 5 μm), it is not conducive to enhancing the stiffness of the corresponding first conductive member 50 or second conductive member 60; and when the thickness of the protective member 70 is large (greater than 40 μm), it is likely to cause the protective member 70 to occupy excessive space, resulting in space waste. By limiting 5 μm≤H2≤40 μm, the stiffness of the corresponding first conductive member 50 or second conductive member 60 is enhanced, and space waste caused by the protective member 70 is reduced, thereby contributing to an increase in the energy density of the electrode plate 100.

Optionally, H2 may be one of 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, or any other value within the range of 5 μm to 40 μm.

Further, 15 μm≤H2≤20 μm, to further enhance the stiffness of the corresponding first conductive member 50 or second conductive member 60 and reduce space waste caused by the protective member 70, thereby contributing to an increase in the energy density of the electrode plate 100.

Referring to FIG. 1 and FIG. 2 together, in some embodiments, along the first direction Z, the thickness H3 of the first conductive member 50 satisfies 8 μm≤H3≤20 μm. When the thickness of the first conductive member 50 is small (less than 8 μm), it is likely to result in weak structural strength of the first conductive member 50, leading to fracture; when the thickness of the first conductive member 50 is large (greater than 20 μm), it is likely to cause the first conductive member 50 to occupy excessive space, resulting in space waste. By limiting 8 μm≤H3≤20 μm, the structural strength of the first conductive member 50 is enhanced, and space waste caused by the first conductive member 50 is reduced, thereby contributing to an increase in the energy density of the electrode plate 100.

Optionally, H3 may be one of 8 μm, 9 μm, 10 μm, 11 μm, 12 μm, 13 μm, 14 μm, 15 μm, 16 μm, 17 μm, 18 μm, 19 μm, 20 μm, or any other value within the range of 8 μm to 20 μm.

Further, 8μm≤H3≤10 μm, to further enhance the structural strength of the first conductive member 50 and reduce space waste caused by the first conductive member 50, thereby contributing to an increase in the energy density of the electrode plate 100.

Referring to FIG. 1 and FIG. 2 together, in some embodiments, along the first direction Z, the thickness H4 of the second conductive member 60 satisfies 8 μm≤H4≤20 μm. When the thickness of the second conductive member 60 is small (less than 8 μm), it is likely to result in weak structural strength of the second conductive member 60, leading to fracture; and when the thickness of the second conductive member 60 is large (greater than 20 μm), it is likely to cause the second conductive member 60 to occupy excessive space, resulting in space waste. By limiting 8 μm≤H4≤20 μm, the structural strength of the second conductive member 60 is enhanced, and space waste caused by the second conductive member 60 is reduced, thereby contributing to an increase in the energy density of the electrode plate 100.

Optionally, H4 may be one of 8 μm, 9 μm, 10 μm, 11 μm, 12 μm, 13 μm, 14 μm, 15 μm, 16 μm, 17 μm, 18 μm, 19 μm, 20 μm, or any other value within the range of 8 μm to 20 μm.

Further, 8 μm≤H4≤10 μm, to further enhance the structural strength of the second conductive member 60 and reduce space waste caused by the second conductive member 60, thereby contributing to an increase in the energy density of the electrode plate 100.

In some embodiments, H3=H4, to help ensure uniform stress distribution on both sides of the current collector 10, thereby improving the structural stability and reliability of the electrode plate 100.

Referring to FIG. 1 and FIG. 2 together, in some embodiments, along the first direction Z, the thickness H5 of the current collector 10 satisfies: 4 μm≤H5≤20 μm, to meet the structural strength requirements of the current collector 10 and reduce space waste caused by the current collector 10 occupying excessive space, thereby contributing to an increase in the energy density of the electrode plate 100.

Optionally, H5 may be one of 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, or any other value within the range of 4 μm to 20 μm.

Further, 6 μm≤H5≤10 μm, to further meet the structural strength requirements of the current collector 10 and reduce space waste caused by the current collector 10 occupying excessive space, thereby contributing to an increase in the energy density of the electrode plate 100.

Referring to FIG. 1 and FIG. 2 together, in some embodiments, along the first direction Z, the thickness H6 of the first transition layer 20 satisfies: 0.5 μm≤H6≤4 μm. When the thickness of the first transition layer 20 is small (less than 0.5 μm), it is likely to result in weak connection strength of the first transition layer 20; and when the thickness of the first transition layer 20 is large (greater than 4 μm), it is likely to cause the first transition layer 20 to occupy excessive space, resulting in space waste. By limiting 0.5 μm≤H6≤4 μm, the connection strength of the first transition layer 20 is enhanced, and space waste caused by the first transition layer 20 is reduced, thereby contributing to an increase in the energy density of the electrode plate 100.

Optionally, H6 may be one of 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, 3 μm, 3.1 μm, 3.2 μm, 3.3 μm, 3.4 μm, 3.5 μm, 3.6 μm, 3.7 μm, 3.8 μm, 3.9 μm, 4 μm, or any other value within the range of 0.5 μm to 4 μm.

Further, 1.5 μm≤H6≤2.5 μm, to further enhance the connection strength of the first transition layer 20 and reduce space waste caused by the first transition layer 20, thereby contributing to an increase in the energy density of the electrode plate 100.

Referring to FIG. 1 and FIG. 2 together, in some embodiments, along the first direction Z, the thickness H7 of the second transition layer 30 satisfies: 0.5 μm≤H7≤4 μm. When the thickness of the second transition layer 30 is small (less than 0.5 μm), it is likely to result in weak connection strength of the second transition layer 30; and when the thickness of the second transition layer 30 is large (greater than 4 μm), it is likely to cause the second transition layer 30 to occupy excessive space, resulting in space waste. By limiting 0.5 μm≤H7≤4 μm, the connection strength of the second transition layer 30 is enhanced, and space waste caused by the second transition layer 30 is reduced, thereby contributing to an increase in the energy density of the electrode plate 100.

Optionally, H7 may be one of 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, 3 μm, 3.1 μm, 3.2 μm, 3.3 μm, 3.4 μm, 3.5 μm, 3.6 μm, 3.7 μm, 3.8 μm, 3.9 μm, 4 μm, or any other value within the range of 0.5 μm to 4 μm.

Further, 1.5 μm≤H7≤2.5 μm, to further enhance the connection strength of the second transition layer 30 and reduce space waste caused by the second transition layer 30, thereby contributing to an increase in the energy density of the electrode plate 100.

In some embodiments, H6=H7, to help ensure uniform stress distribution on both sides of the current collector 10, thereby improving the structural stability and reliability of the electrode plate 100.

Referring to FIG. 1 and FIG. 2 together, in some embodiments, along the second direction X, the width W4 of the second segment 10b satisfies 1 mm≤W4≤5 mm. When the width of the second segment 10b is small (less than 1 mm), it is likely to result in a small connection region between the second segment 10b and the first conductive member 50 and the second conductive member 60, leading to weak connection strength; when the width of the second segment 10b is large (greater than 5 mm), it is likely to cause the second segment 10b to occupy excessive space, resulting in space waste. By limiting 1 mm≤W4≤5 mm, the connection strength between the second segment 10b and the first conductive member 50 and the second conductive member 60 is enhanced, and space waste caused by the second segment 10b is reduced, thereby contributing to an increase in the energy density of the electrode plate 100.

Optionally, W4 may be one of 1 mm, 2 mm, 3 mm, 4 mm, 5 mm, or any other value within the range of 1 mm to 5 mm.

Further, 1.5 mm≤W4≤2.2 mm, to further enhance the connection strength between the second segment 10b and the first conductive member 50 and the second conductive member 60, and reduce space waste caused by the second segment 10b, thereby contributing to an increase in the energy density of the electrode plate 100.

Referring to FIG. 1 and FIG. 2 together, in some embodiments, the current collector 10 further includes a third segment 10c. Along the second direction X, the third segment 10c is located at an end of the first segment 10a away from the second segment 10b, and the third segment 10c is configured to connect to an electrode terminal. The width W5 of the third segment satisfies 1 mm≤W5≤5 mm. When the width of the third segment 10c is small (less than 1 mm), it is likely to result in a small connection region between the third segment 10c and the electrode terminal, leading to weak connection strength; and when the width of the third segment 10c is large (greater than 5 mm), it is likely to cause the third segment 10c to occupy excessive space, resulting in space waste. By limiting 1 mm≤W5≤5 mm, the connection strength between the third segment 10c and the electrode terminal is enhanced, and space waste caused by the third segment 10c is reduced, thereby contributing to an increase in the energy density of the electrode plate 100.

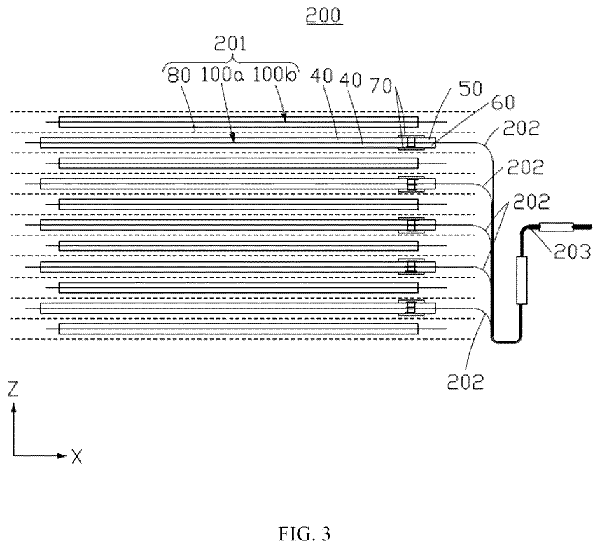

Referring to FIG. 3, an embodiment of the present application further provides a battery cell 200, including an electrode assembly 201, where the electrode assembly 201 includes any one of the electrode plates 100 described in the above embodiments.

In some embodiments, the electrode assembly 201 includes a first electrode plate 100a, a separator 80, and a second electrode plate 100b sequentially stacked along the first direction Z. The first electrode plate 100a exhibits positive polarity, and the second electrode plate 100b exhibits negative polarity. At least one of the first electrode plate 100a and the second electrode plate 100b serves as the electrode plate 100. When the first electrode plate 100a serves as the electrode plate 100, the corresponding active substance layer 40 exhibits positive polarity; and when the second electrode plate 100b serves as the electrode plate 100, the corresponding active substance layer 40 exhibits negative polarity.

In some embodiments, the first electrode plate 100a serves as the electrode plate 100, and a plurality of first electrode plates 100a are arranged at intervals along the first direction Z. Along the first direction Z, projections of the second segment 10b of the plurality of first electrode plates 100a at least partially overlap. The protective members 70 insulate and isolate the corresponding weld marks 55 from the adjacent second electrode plate 100b, reducing the risk of internal short circuits in the battery cell 200.

In some embodiments, the battery cell 200 further includes a plurality of tabs 202 and a tab lead 203. One end of each tab 202 is connected to the first conductive member 50 and the second conductive member 60 of the first electrode plate 100a, and the other end of each tab 202 extends outward. The outwardly extending ends of the plurality of tabs 202 are gathered and interconnected on one side of the electrode assembly 201 to connect to the tab lead 203. The tab lead 203 is configured to connect to an external circuit.

In some embodiments, along the second direction X, the projection of the tab 202 lies within the projection range of the electrode assembly 201 to improve the space utilization rate of the tab 202 on one side of the electrode assembly 201, thereby increasing the energy density of the battery cell 200.

Optionally, the gathered portion of the plurality of tabs 202 is bent to facilitate connection with the tab lead 203.

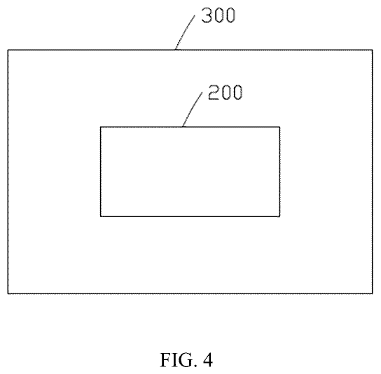

Referring to FIG. 4, an embodiment of the present application further provides an electric device 300, including the electrode plate 100 described in any one of the above embodiments or the battery cell 200 described in any one of the above embodiments. The electric device 300 may be a vehicle, a mobile phone, a portable device, a laptop, a ship, a spacecraft, an electric toy, an electric tool, or the like.

In summary, in the above electrode plate 100, battery cell 200, and electric device, one of the protective members 70 has its two ends respectively bonded to a surface of the first conductive member 50 facing away from the current collector 10 and a surface of the corresponding active substance layer 40 facing away from the first transition layer 20, to enhance the stability of the connection between the first conductive member 50 and the current collector 10. The other protective member 70 has its two ends respectively bonded to a surface of the second conductive member 60 facing away from the current collector 10 and a surface of the corresponding active substance layer 40 facing away from the second transition layer 30, to enhance the stability of the connection between the second conductive member 60 and the current collector 10. Viewed along the second direction X, the weld mark 55 connected to the current collector 10 is located between the two protective members 70. The two protective members 70 are configured to protect both sides of the corresponding weld mark 55, and under the support of the protective members 70, the stiffness of the first conductive member 50 and the second conductive member 60 located between the two protective members 70 is enhanced. This helps improve the structural strength of the corresponding weld mark 55, reduces the risk of damage to the weld mark 55 connected to the current collector 10, and prevents burrs generated by the weld mark 55 from damaging other components, thereby improving the reliability of the electrode plate 100.

In addition, those skilled in the art may make other changes within the spirit of the present application. It is to be understood that these changes made in accordance with the spirit of the present application should be included within the scope disclosed by the present application.

What is claimed is:

1. An electrode plate, comprising:
a current collector comprising a support layer, a first conductive layer and a second conductive layer; the first conductive layer and the second conductive layer are disposed on two sides of the support layer respectively in a first direction, wherein the first direction is a thickness direction of the current collector, and the current collector comprising a first segment and a second segment sequentially disposed along a second direction, wherein the first direction is perpendicular to the second direction;
a first transition layer located in the first segment and disposed on a surface of the first conductive layer facing away from the support layer;
a second transition layer located in the first segment and disposed on a surface of the second conductive layer facing away from the support layer;
two active substance layers, wherein one active substance layer is disposed on a surface of the first transition layer facing away from the current collector, and the other active substance layer is disposed on a surface of the second transition layer facing away from the current collector;
a first conductive member disposed on the surface of the first conductive layer facing away from the support layer, wherein one end of the first conductive member is located in the second segment, and viewed along the first direction, the first conductive member is spaced apart from the first transition layer, and the other end of the first conductive member protrudes beyond the current collector in the second direction;
a second conductive member disposed on the surface of the second conductive layer facing away from the support layer, wherein one end of the second conductive member is located in the second segment, viewed along the first direction, the second conductive member is spaced apart from the second transition layer, and the other end of the second conductive member protrudes beyond the current collector in the second direction, the first conductive member and the second conductive member being welded to form a plurality of weld marks arranged along the second direction, at least one weld mark being further connected to the current collector; and
two protective members respectively located on two sides of the current collector in the first direction, wherein one protective member has its two ends respectively bonded to a surface of the first conductive member facing away from the current collector and a surface of the corresponding active substance layer facing away from the first transition layer, the other protective member has its two ends respectively bonded to a surface of the second conductive member facing away from the current collector and a surface of the corresponding active substance layer facing away from the second transition layer, and viewed along the second direction, the weld mark connected to the current collector is located between the two protective members.

2. The electrode plate according to claim 1, wherein, along the second direction, a spacing L1 between the first conductive member and the first transition layer satisfies: 0.05 mm≤L1≤0.5 mm; and a spacing L2 between the second conductive member and the second transition layer satisfies: 0.05 mm≤L2≤0.5 mm.

3. The electrode plate according to claim 2, wherein 0.2 mm≤L1≤0.3 mm; and 0.2 mm≤L2≤0.3 mm.

4. The electrode plate according to claim 1, wherein, along the second direction, a spacing L3 between the first transition layer and an adjacent weld mark satisfies 0.05 mm≤L3≤1 mm; and a spacing L4 between the second transition layer and an adjacent weld mark satisfies 0.05 mm≤L4≤1 mm.

5. The electrode plate according to claim 4, wherein 0.1 mm≤L3≤0.2 mm; and 0.1 mm≤L4≤0.2 mm.

6. The electrode plate according to claim 1, wherein, along the second direction, a width W1 of each weld mark satisfies: 1.5 mm≤W1≤4 mm; and along the first direction, a height H1 of each weld mark satisfies: 20 μm≤H1≤50 μm.

7. The electrode plate according to claim 6, wherein 1.6 mm≤W1≤2.2 mm; and 30 μm≤H1≤35 μm.

8. The electrode plate according to claim 1, wherein, along the second direction, a width W2 of each protective member satisfies 1.2 mm≤W2≤5 mm; and a width W3 of the bonding region between each protective member and the corresponding active substance layer satisfies 0<W3≤1 mm.

9. The electrode plate according to claim 8, wherein 2 mm≤W2≤2.4 mm; and 0.2 mm≤W3≤0.4 mm.

10. The electrode plate according to claim 1, wherein, along the first direction, a thickness H2 of each protective member satisfies: 5 μm≤H2≤40 μm.

11. The electrode plate according to claim 10, wherein 15 μm≤H2≤20 μm.

12. The electrode plate according to claim 1, wherein, along the first direction, a thickness H3 of the first conductive member satisfies 8 μm≤H3≤20 μm; and a thickness H4 of the second conductive member satisfies 8 μm≤H4≤20 μm.

13. The electrode plate according to claim 12, wherein 8 μm≤H3≤10 μm; and 8 μm≤H4≤10 μm.

14. The electrode plate according to claim 1, wherein, along the first direction, a thickness H5 of the current collector satisfies: 4 μm≤H5≤20 μm; a thickness H6 of the first transition layer satisfies: 0.5 μm≤H6≤4 μm; and a thickness H7 of the second transition layer satisfies: 0.5 μm≤H7≤4 μm.

15. The electrode plate according to claim 14, wherein 6 μm≤H5≤10 μm; 1.5 μm≤H6≤2.5 μm; and 1.5 μm≤H7≤2.5 μm.

16. The electrode plate according to claim 1, wherein, along the second direction, a width W4 of the second segment satisfies 1 mm≤W4≤5 mm.

17. The electrode plate according to claim 16, wherein 1.5 mm≤W4≤2.2 mm.

18. The electrode plate according to claim 1, wherein the current collector further comprises a third segment, along the second direction, the third segment is located at an end of the first segment away from the second segment, the third segment is configured to connect to an electrode terminal, and a width W5 of the third segment satisfies 1 mm≤W5≤5 mm.

19. The electrode plate according to claim 1, wherein the first transition layer and the second transition layer each comprise an inorganic material, a polymer material, and conductive particles, wherein the inorganic material comprises one or more of alumina, boehmite, silica, water-insoluble carbonates, and water-insoluble sulfates, and the polymer material comprises one or more of polyolefins, polyesters, and rubbers.

20. A battery cell comprising an electrode assembly, wherein the electrode assembly comprises the electrode plate according to claim 1.

21. An electric device comprising the battery cell according to claim 20.
